(19) United States
(12) Patent Application Publication
(10) Pub. No.: US 2012/0133590 A1
(43) Pub. Date: May 31, 2012

(54) INPUT METHOD AND APPARATUS OF PORTABLE TERMINAL WITH TOUCH SCREEN

(75) Inventor: Kun-Woo BAEK, Gyeongsangbuk-do (KR)

(73) Assignee: Samsung Electronics Co., Ltd., Gyeonggi-Do (KR)

(21) Appl. No.: 13/306,000

(22) Filed: Nov. 29, 2011

(30) Foreign Application Priority Data
Nov. 29, 2010 (KR) 10-2010-0120030

(51) Int. Cl. G06F 3/02

(52) U.S. Cl. 345/169

(57) ABSTRACT

An input method of a portable terminal having a touch screen includes: converting a mode of the portable terminal to an input mode, activating a virtual keypad, and then displaying the activated virtual keypad; recognizing whether key input interrupts, which are generated from keys of the displayed virtual keypad, are successively generated on at least two adjacent keys; and performing a function corresponding to the key input interrupt generated on the virtual keypad.

### CLAIM OF PRIORITY

This application claims priority under 35 U.S.C. §119 to a Korean Patent Application entitled “Input Method and Apparatus of Portable Terminal with Touch Screen” filed in the Korean Intellectual Property Office on Nov. 29, 2010 and assigned Serial No. 10-2010-0120030, the contents of which are incorporated herein by reference.

### BACKGROUND OF THE INVENTION

1. Field of the Invention

The present invention relates to an input of a portable terminal, and more particularly to a virtual keypad for the portable terminal.

2. Description of the Related Art

In general, a portable terminal has a very large number of functions including an MP3 function, a game function, and functions of transmitting and storing various information as well as a communication function. To use these function, the portable terminal includes a keypad formed by a combination of keys or a touch screen.

FIG. 1 illustrates a conventional virtual keypad displayed on the touch screen of the portable terminal. Since such a keypad is displayed on a small touch screen unlike a computer screen, the keypad has frequent input errors. Further, when a user desires to input numbers or an English character, the user has to perform a key mode conversion several times, as shown in FIGS. 1A, 1B, and 1C. Accordingly, there is a need for improved way of providing a desired input.

### SUMMARY OF THE INVENTION

Accordingly, the present invention provides an input method and an input apparatus of the portable terminal having the touch screen, in which shortcut key symbols for performing specific service functions are mapped to each of the keys of the virtual keypad, wherein the virtual keypad is converted to a keypad having a layout type of a key arrangement related to the shortcut key function mapped to the corresponding key when the key recognizes an input by a user, so that the user can accurately recognize the shortcut key function, which the user desires to input, on the keypad.

In accordance with an aspect of the present invention, an input method of a portable terminal having a touch screen includes: converting a mode of the portable terminal to an input mode, activating a virtual keypad, and then displaying the activated virtual keypad on the touch screen; recognizing whether key input interrupts, which are generated in keys of the displayed virtual keypad, are successively generated in at least two keys; and performing an input preset to the key, in which the key input interrupt is generated.

In accordance with another aspect of the present invention, a terminal includes a touch screen for displaying a virtual key pad having a plurality of virtual keys, to each of which one or more functional objects and shortcut keys are pre-assigned; and a controller for recognizing an input of a first virtual key and a second virtual key is successively generated and displaying a layout corresponding to the recognized input on the touch screen.

In accordance with another aspect of the present invention, an input apparatus of a portable terminal having a touch screen includes: a virtual keypad including keys, in which one or more functional objects and shortcut keys are mapped to each of the keys; a display unit to display the virtual keypad including a plurality of virtual keys, and a key input, in which a key input interrupt is generated in the virtual keypad; and a controller to recognize the key input interrupt generated in the keys of the virtual keypad displayed on the display unit, to identify whether the key input interrupts are successively generated in at least two keys, and to control such that an input preset to the key, in which the key input interrupt is generated, is performed.

### BRIEF DESCRIPTION OF THE DRAWINGS

The above and other aspects, features and advantages of the present invention will be more apparent from the following detailed description taken in conjunction with the accompanying drawings, in which:

FIGS. 1A to 1C illustrate examples of a virtual keypad displayed on a conventional touch screen of a portable terminal;

FIG. 2 is a flowchart illustrating an input method of a portable terminal having a touch screen according to an embodiment of the present invention;

FIGS. 3A to 3D illustrate examples of an input of a portable terminal having a touch screen according to an embodiment of the present invention;

FIGS. 4A and 4B illustrate examples of screens on which a setting menu activation service function of the keypad is displayed due to a key input interrupt generated in a virtual keypad of a layout type having a qwerty key arrangement by a user according to an embodiment of the present invention.

FIG. 5 is a block diagram illustrating an input apparatus of a portable terminal having a touch screen according to an embodiment of the present invention.

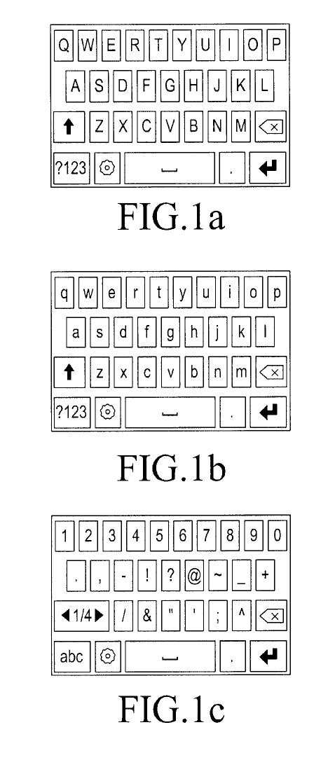

### DETAILED DESCRIPTION OF THE INVENTION

Hereinafter, the first exemplary embodiments of the present invention will be described with reference to the accompanying drawings. In the following description, although a preferred embodiment of the present invention has been described for illustrative purposes, those skilled in the art will appreciate that various modifications, additions and substitutions are possible, without departing from the scope and spirit of the invention as disclosed in the accompanying claims.

Briefly, the present invention enables a user to conveniently use a shortcut key function assigned to each of keys of a virtual keypad displayed on a touch screen of a portable terminal with the touch screen. When the users desire to perform a specific service function such as a language input mode conversion for another language, a capital/small letter conversion, a copy, a paste, a cut, a setting menu of the keypad, a layout of the keypad, etc., a key input interrupt type generated in the keypad is recognized and a key arrangement layout for a corresponding specific service function is displayed in the virtual keypad, so that the user can sharply reduce the time required for inputting various shortcut key functions without cumbersomely controlling the keys.

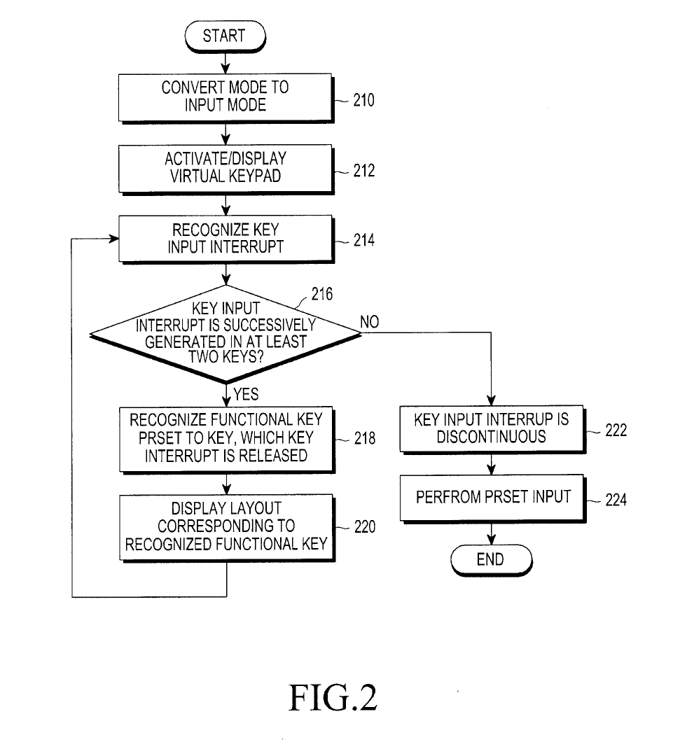

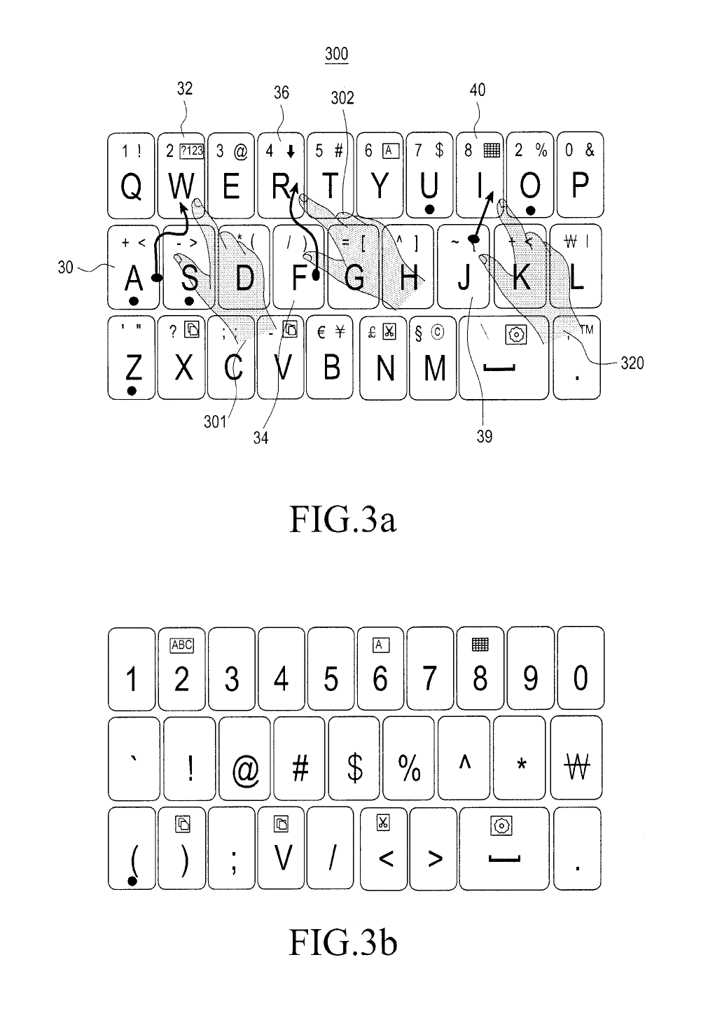

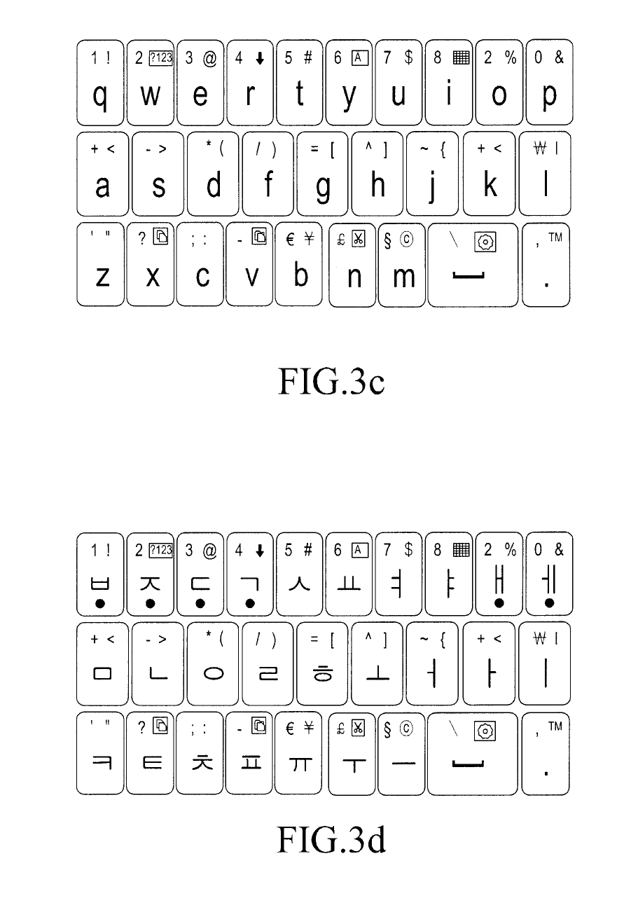

Hereinafter, an input method of the portable terminal having the touch screen according to an embodiment of the present invention will be described in detail with reference to FIGS. 2 and 3.

In the specification, it should be noted that the teachings of the present invention can be in a portable terminal having a touch screen as well as all other information telecommunication apparatuses and multimedia apparatuses, such as a digital broadcasting terminal, a Personal Digital Assistant (PDA), a smart phone, and a 3G terminal, for example, a International Mobile Telecommunication 2000 (IMT-2000) terminal, a Wideband Code Division Multiple Access (WCDMA) terminal, a Global System for Mobile Communication Packet Radio Service (GSM/GPRS) terminal, and a Universal Mobile Telecommunication Service (UMTS) terminal, and the application of the above apparatuses.

FIG. 2 is a flowchart illustrating an input method of the portable terminal having the touch screen according to an embodiment of the present invention.

In step 210, a current mode of the portable terminal is converted to an input mode.

In step 212, the virtual keypad is activated and displayed on the touch screen. The virtual keypad has a construction of a layout type having a qwerty key arrangement, as shown in FIG. 3A.

In the embodiment, one or more functional objects and shortcut keys are mapped to each of the keys included in the virtual keypad. Each of the functional objects mapped to each of the keys include a number, a letter for different language e, a symbol, and a special character, and the shortcut keys for each function are represented as an item indicative of a performance of the specific service function such as a language input mode conversion, a capital/small letter conversion, a copy, a paste, a cut, a setting menu of the keypad, and a layout of the keypad, etc.

In step 214, the key input interrupt generated by a specific key among the keys of the virtual keypad displayed in step 212 is recognized.

In the specification, the key input interrupt refers to one pointing operation which may include a touch operation, a flick operation, and a drag operation generated in a corresponding key area by contacting the touch screen of the portable terminal by the user. In the embodiment of the present invention, the touch operation and the drag operation will be mainly described for illustrative purpose, but it should be noted that other motion operation applicable to the touch screen can be applied

In step 216, it is determined as to whether the key input interrupts generated on the displayed virtual keypad are successively generated on at least two keys thereof.

Operations of steps 210-216 are schematically described in FIG. 3. FIG. 3A illustrates the virtual keypad 300 having a construction of the layout type having the qwerty key arrangement according to an embodiment of the present invention. Here, it is determined whether the key input interrupts are successively generated on at least two keys 30 and 32 of the virtual keypad 300 by the user 301. That is, it is determined whether a drag operation occurs from the key 30 and to key 32 by a user 301.

In step 216, when the key input interrupts are successively generated on at least two key buttons, a shortcut key, which is predetermined in a corresponding key drag operation from the key 30 to the key 32, is recognized in step 218. An input to the key indicates a start of the key input interrupt, and a release after dragging on the key 32 indicates a release of the key input interrupt. As a result, a shortcut key (Box: ?123)for performing a number service function and a symbol service function assigned to the key 32 is recognized since the key 32 contains a symbol indicative of such a short key.

Thereafter, in step 220, a layout corresponding to the recognized shortcut key is displayed in the virtual keypad 300. The layout is represented as a layout type having a key arrangement shown in FIG. 3B and has a shortcut key layout type only for the number and the symbol specified by the key 32. Therefore, the activation of a shift key used for an input of the number and the symbol in the conventional keypad is omitted in the present invention by a mere drag operation between adjacent keys 30 and 32, as shown from FIG. 3A to FIG. 3B. Alternatively, any key adjacent to the key 32 can be activated first and then dragged to the key 32 to perform the same function.

If it is determined that the key input interrupts are successively generated on at least two keys 34 and 36 of the virtual keypad 300 by the user's drag operation 302 in FIG. 3A, a layout type having a key arrangement shown in FIG. 3C is displayed in the virtual keypad 300. In the layout shown in FIG. 3C, an input to the key 34 recognizes a start of the key input interrupt and a drag to the key 36 indicates a release of the key input interrupt to perform the small letter conversion (indicated by downward arrow). Thereafter, the keypad of the layout shown in FIG. 3C is displayed which is a keypad for performing a small letter conversion service function assigned to the key 36. Accordingly, the activation of a shift key used for an input of lower key letters in the conventional keypad can be omitted in the present invention by a mere drag operation between adjacent keys 34 and 36, as shown from FIG. 3A to FIG. 3C.

If the key input interrupts are successively generated on at least two keys 39 and 40 of the virtual keypad 300 by the user 320 through a drag operation in FIG. 3A, a layout type having a key arrangement shown in FIG. 3D is displayed in the virtual keypad 300. In the layout shown in FIG. 3D, an input to the key 39 indicates a start of the key input interrupt, and a drag to the key 40 indicates a release of the key input interrupt to perform another language selection. The keypad of the layout shown in FIG. 3D is a keypad for performing a previous language conversion service function, and FIG. 3D illustrates an embodiment in the case where the previous language is Korean. Accordingly, the activation of a shift key used for an input of another language in the conventional keypad can be omitted in the present invention by a mere drag operation between adjacent keys 39 and 40, as shown from FIG. 3A to FIG. 3D.

Meanwhile, in step 216, when the key input interrupts are not successively generated on at least two key buttons, the key input interrupt is recognized to be discontinuous in step 222. Then, it proceeds to step 224 where an input assigned to the corresponding single key is performed.

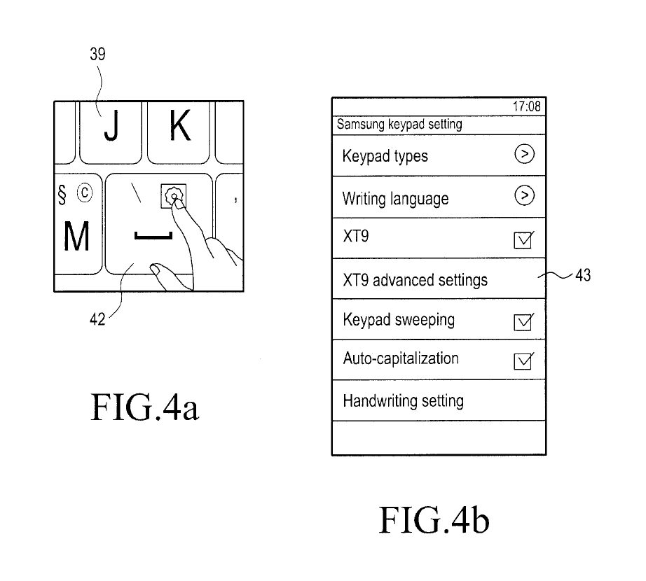

FIGS. 4A and 4B are illustrate examples of screens on which a setting menu activation service function of the keypad is displayed due to a key input interrupt generated in a virtual keypad according to an embodiment of the present invention. Referring to FIG. 4A, when the key input interrupts are generated on keys 39 to 42 via a drag operation, the setting menu activation service function assigned to the key 42 is displayed on the touch screen of the portable terminal as shown in FIG. 4B, then the setting menu of the keypad can be inputted by a user.

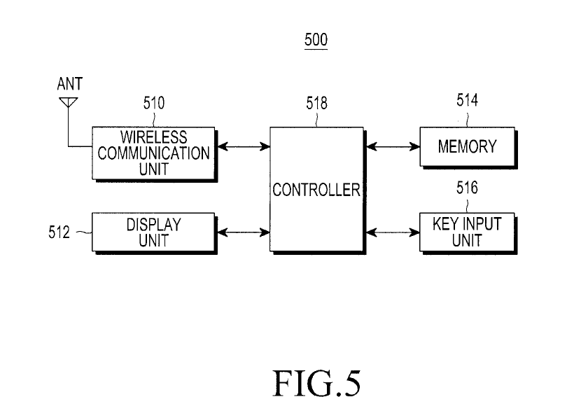

Hereinafter, an input apparatus of the portable terminal having the touch screen according to an embodiment of the present invention will be described in detail with reference to FIG. 5.

FIG. 5 is a block diagram illustrating the input apparatus of the portable terminal having the touch screen according to an embodiment of the present invention.

Referring to FIG. 5, the portable terminal 400 having the touch screen includes a wireless communication unit 510, a display unit 512, a memory 514, a virtual keypad 516, and a controller 518.

The wireless communication unit 510 outputs downlink data obtained by demodulating a wireless downlink signal, to the controller 518. Further, the wireless communication unit 510 generates the wireless uplink signal by modulating uplink data input from the controller 518, and then wirelessly transmits the generated wireless uplink signal through an antenna. Such modulation and demodulation may be preferably performed according to a Code Division Multiple Access (CDMA) method and also performed according to a Frequency Division Multiplexing (FDM) method, a Time Division Multiplexing (TDM) method, etc.

The display unit 512 displays the virtual keypad formed by a combination of plural virtual keys, and the virtual keypad displays an key input in which the key input interrupt is generated.

The virtual keypad 516 has a certain key arrangement including keys arranged in a predetermined layout, to which one or more functional objects and shortcut keys are mapped.

The memory controller 514 can store a program for a processing and a control of the controller 518 or stores letters for each nation, etc. displayed on the virtual keypad.

Further, the controller 518 recognizes the key input interrupt generated in the keys of the virtual keypad displayed on the display unit 512, recognizes whether the key input interrupts are successively generated on at least two key buttons, and controls such that a predetermined function corresponding to the key input interrupts can be performed.

That is, the controller 518 recognizes the shortcut key assigned to the second key and controls such that a layout corresponding to the recognized shortcut key is displayed in the virtual keypad.

As described above, one skilled in the art would readily appreciate that that the teachings of the present invention contributes to the convenience of users in that the user can sharply reduce the time required for inputting various shortcut key functions without cumbersomely controlling the keys, while accurately recognizing the shortcut key functions, which the user desires to input, on the keypad.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the present invention has been shown and described with reference to certain exemplary embodiments and drawings thereof, it will be understood by those skilled in the art that various changes in form and details may be made therein without departing from the spirit and scope of the invention as defined by the appended claims.

What is claimed is:

1. An input method for a portable terminal having a touch screen, method comprising:
displaying a virtual keypad on the touch screen;
recognizing whether key input interrupts are successively generated on at a first key button and a second key button of the virtual keypad; and
performing a preset function corresponding to the second key button.

2. The input method as claimed in claim 1, wherein each of key buttons of the virtual keypad is pre-assigned with a shortcut key for performing different functions.

3. The input method as claimed in claim 1, wherein the key input interrupt comprises one of a touch operation, a tap operation, a flick operation, and a drag operation generated on the virtual key pad.

4. The input method as claimed in claim 1, wherein, when the key input interrupts are successively generated on at least two adjacent key buttons.

5. The input method as claimed in claim 1, wherein performing the present function corresponding to the second key button comprises converting the virtual keypad to another virtual key pad.

6. The input method as claimed in claim 1, wherein, when the key input interrupts are not successively generated, an input assigned to a particular key button is performed.

7. The input method as claimed in claim 4, wherein a layout corresponding to recognizable shortcut keys is displayed in the virtual keypad.

8. The input method as claimed in claim 1, wherein the virtual keypad has a layout type having a qwerty key arrangement.

9. An input apparatus of a portable terminal having a touch screen, comprising:
a virtual keypad including a plurality of virtual keys, to each of which one or more functional objects and shortcut keys are mapped;
a display unit to display the virtual keypad, on which a key input interrupt is generated; and
a controller to recognize the key input interrupt generated on the virtual keypad displayed on the display unit, to identify whether the key input interrupts are successively generated on at least two adjacent keys, and to control such that a function mapped to one of the at least two adjacent keys, is performed.

10. The input apparatus as claimed in claim 9, where in the controller recognizes a shortcut key assigned to one of the at least two adjacent and controls such that a layout corresponding to the recognized shortcut key is displayed in the virtual keypad.

11. The input apparatus as claimed in claim 9, wherein the one or more functional objects comprise a number, a letter for each nation, a symbol, and a special character.

12. The input apparatus as claimed in claim 9, wherein the shortcut key represents a specific service function, which includes as a language input mode conversion for another language, a capital/small letter conversion, a copy, a paste, a cut, a setting menu of the keypad, and a layout of the keypad, in a predetermined area for each key.

13. The input apparatus as claimed in claim 9, wherein, when the key input interrupts are not successively generated, the controller controls such that an input assigned to a single key is performed.

14. A terminal, comprising:
a touch screen for displaying a virtual key pad having a plurality of virtual keys, to each of which one or more functional objects and shortcut keys are pre-assigned; and
a controller for recognizing an input of a first virtual key and a second virtual key is successively generated and displaying a layout corresponding to the recognized input on the touch screen.

15. The terminal as claimed in claim 14, wherein displaying the layout comprises converting the virtual keypad to another virtual key pad.

16. The terminal as claimed in claim 14, wherein the virtual keypad has a layout type having a qwerty key arrangement.

17. The terminal as claimed in claim 14, wherein the one or more functional objects comprise a number, a letter for each nation, a symbol, and a special character.

18. The terminal as claimed in claim 14, wherein the shortcut key represents a specific service function, which includes as a language input mode conversion for another language, a capital/small letter conversion, a copy, a paste, a cut, a setting menu of the keypad, and a layout of the keypad, in a predetermined area for each key.
